(19) United States
(12) Patent Application Publication
(10) Pub. No.: US 2014/0084741 A1
(43) Pub. Date: Mar. 27, 2014

(54) ROTATING ELECTRICAL MACHINE AND ELECTRIC POWER STEERING SYSTEM USING THE SAME

(71) Applicant: Hitachi Automotive Systems, Ltd., Ibaraki (JP)

(72) Inventors: Norihisa IWASAKI, Tokyo (JP); Masashi KITAMURA, Tokyo (JP); Hiroshi KANAZAWA, Hitachinaka (JP); Shozo KAWASAKI, Hitachinaka (JP)

(73) Assignee: Hitachi Automotive Systems, Ltd., Ibaraki (JP)

(21) Appl. No.: 13/972,472

(22) Filed: Aug. 21, 2013

(30) Foreign Application Priority Data
Sep. 27, 2012 (JP) 2012-213383

(51) Int. Cl. H02K 1/16

(52) U.S. Cl. CPC H02K 1/16
USPC 310/216.091

(57) ABSTRACT

A permanent magnet rotating electrical machine includes: a stator including a stator core and a polyphase stator coil incorporated into the stator core; and a rotor including a rotor core and a plurality of permanent magnets which is fixed to the outer peripheral surface of the rotor core, wherein the stator core has a plurality of stator tooth portions forming a slot into which the stator coil is stored, the rotor core is rotatably disposed in opposed relation to the stator, and the stator tooth portion includes at the tip thereof at least one nonmagnetic inner region.

### BACKGROUND OF THE INVENTION

1. Field of the Invention

The present invention relates to a rotating electrical machine and an electric power steering system using the same.

2. Description of the Related Art

In response to the recent trend of replacing a hydraulic system by an electric system as well as introducing a hybrid electric vehicle (HEV) and an electric vehicle (EV) on the market, there has been a rapid increase in the percentage of vehicles equipped with an electric power steering (EPS). An EPS motor is provided to assist a human hand in steering a steering wheel, whereby a driver would feel in his/her hands torque ripple/friction of the motor provided between the hands and tires through the steering wheel. Accordingly, there is a stringent requirement for the EPS motor pertaining to the torque ripple. There is likewise a stringent requirement pertaining to vehicle interior noise generated by friction and vibration among mechanical parts so that a driver and a passenger would not be annoyed by the noise. Especially in recent years, an increasing number of vehicles have achieved low engine sound as an effect of an idling stop function or the like, where the noise reduction of an electrical component is highly valued.

As a technology to abate cogging torque and the torque ripple, JP-62-11048-A and JP-2009-171790-A disclose a method, for example, in which a ratio of the number of poles to the number of slots is set to either 10:12 or 14:12, and a slot opening width and a magnet shape are set to fall within a certain threshold. In addition, as described in JP-2011-67090-A, there is a method in which a groove is provided at the tip of a tooth to abate the cogging torque. WO 08/102,439 further discloses a method in which a slit is provided in a rotor core as a technology to abate vibration and noise.

### SUMMARY OF THE INVENTION

The combination of the number of poles and the number of slots becomes highly important in the abatement of the cogging torque and the torque ripple of the motor, as described in JP-62-110468-A and JP-2009-171790-A. When a motor with 12 slots employing a concentrated winding pattern is provided, for example, the number of poles that can be selected is 8, 10, 14, and the like. Here, superior characteristic can be obtained regarding the abatement of the cogging torque and the torque ripple by selecting 10 or 14 poles. Such combination of the number of poles and the number of slots however causes a radial component of electromagnetic force to be in a second space mode, thereby causing a stator housing more likely to deform and thus bringing about the vibration/noise with greater likelihood.

A permanent magnet rotating electrical machine according to the present invention includes: a stator including a stator core and a polyphase stator coil incorporated into the stator core; and a rotor including a rotor core and a plurality of permanent magnets which is fixed to the outer peripheral surface of the rotor core, wherein the stator core has a plurality of stator tooth portions each forming a slot into which the stator coil is stored, the rotor core is rotatably disposed in opposed relation to the stator, and the stator tooth portion includes, at the tip thereof, at least one nonmagnetic inner region.

The ratio of the number of poles to the number of slots may also be an integral multiple of 10:12 or an integral multiple of 14:12.

According to the present invention, a component among the radial component of the electromagnetic force that is in a low order space mode can be reduced.

Moreover, the cogging torque and the torque ripple can be abated by having the ratio of the number of poles to the number of slots to be the integral multiple of 10:12 or the integral multiple of 14:12.

### BRIEF DESCRIPTION OF THE DRAWINGS

FIG. 1 is a diagram illustrating an electric power steering system according to an embodiment of the present invention;

FIG. 2A is a diagram illustrating an electric power steering system according to an embodiment of the present invention;

FIG. 2B is a diagram illustrating an electric power steering system according to an embodiment of the present invention;

FIG. 3A is a diagram illustrating an electric power steering system according to an embodiment of the present invention;

FIG. 3B is a diagram illustrating an electric power steering system according to an embodiment of the present invention;

FIG. 4 is a diagram illustrating an electric power steering motor and a control unit according to an embodiment of the present invention;

FIG. 5A is a diagram illustrating a construction of an electric power steering motor according to an embodiment of the present invention;

FIG. 5B is a diagram illustrating a construction of a rotor in an electric power steering motor according to an embodiment of the present invention;

FIG. 5C is a diagram illustrating the assembling of a split stator core and a bobbin in an electric power steering motor according to an embodiment of the present invention;

FIG. 6A is a diagram illustrating the winding arrangement of a stator in an electric power steering motor according to an embodiment of the present invention;

FIG. 6B is a diagram illustrating the assembling of a stator core in an electric power steering motor according to an embodiment of the present invention;

FIG. 6C is an axial cross-sectional view of a stator in an electric power steering motor according to an embodiment of the present invention;

FIG. 7 is a graph illustrating the calculation result of electromagnetic force in a radial direction in a second space mode generated in each of an electric power steering motor according to an embodiment of the present invention and a 10-pole, 12-slot motor of the related art;

FIG. 8A is a graph illustrating the calculation result of electromagnetic force in a radial direction in a second space mode generated in an electric power steering motor according to an embodiment of the present invention, where bridge width/tooth width=0.03;

FIG. 8B is a graph illustrating the calculation result of torque ripple generated in an electric power steering motor according to an embodiment of the present invention, where bridge width/tooth width=0.03;

FIG. 8C is a graph illustrating the calculation result of electromagnetic force in a radial direction in a second space mode generated in an electric power steering motor according to an embodiment of the present invention, where bridge width/tooth width=0.06;

FIG. 8D is a graph illustrating the calculation result of torque ripple generated in an electric power steering motor according to an embodiment of the present invention, where bridge width/tooth width=0.06;

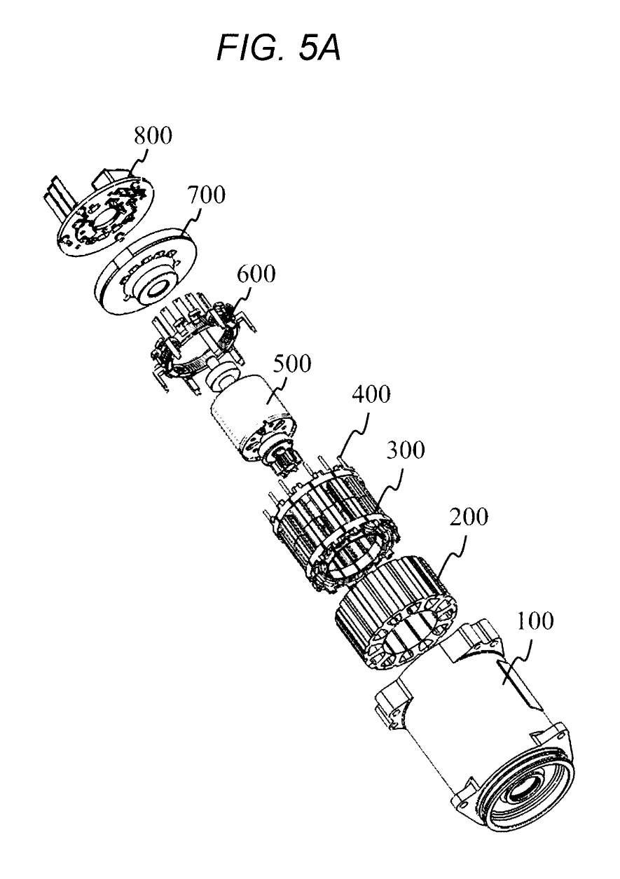

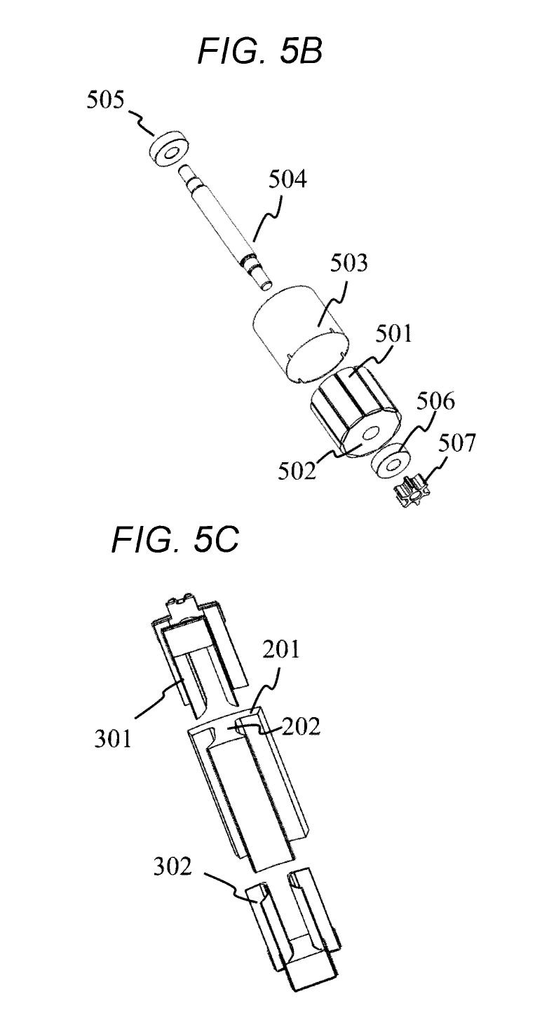

FIG. 5E is a graph illustrating the calculation result of electromagnetic force in a radial direction in a second space mode generated in an electric power steering motor according to an embodiment of the present invention, where bridge width/tooth width=0.13;

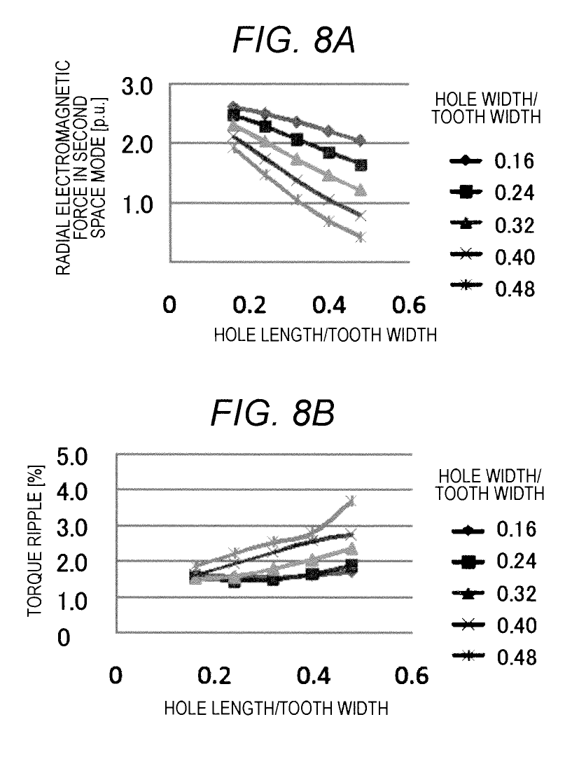

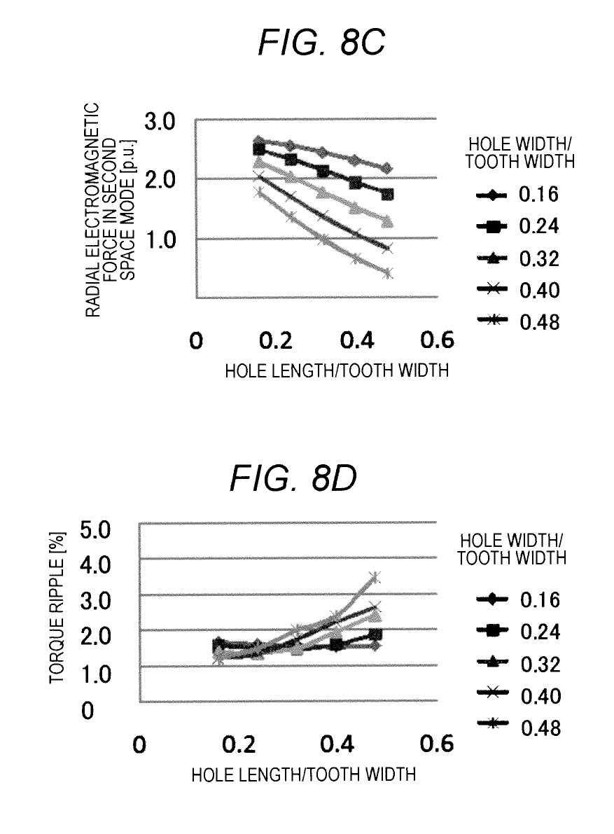

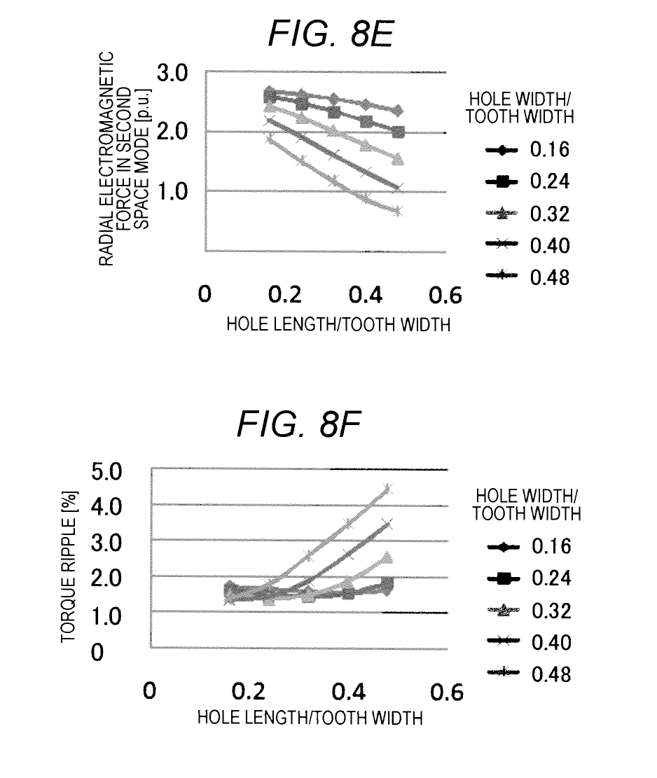

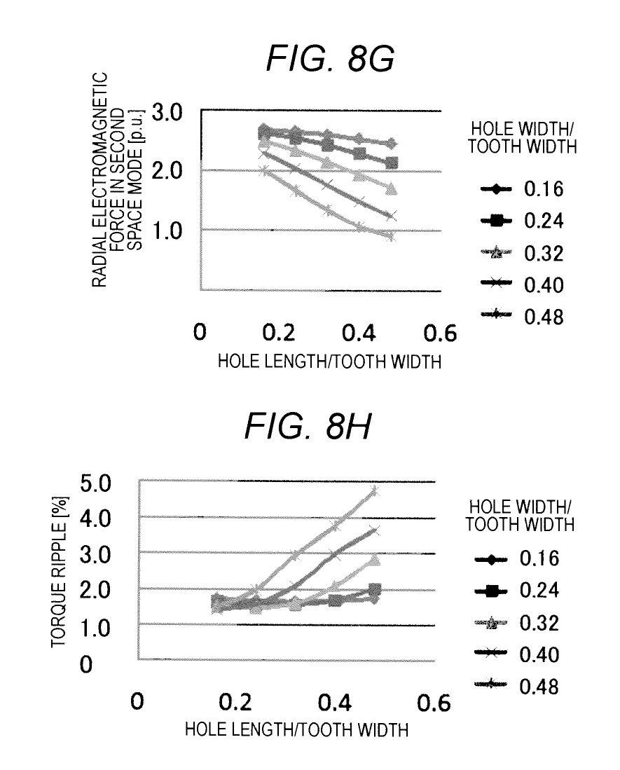

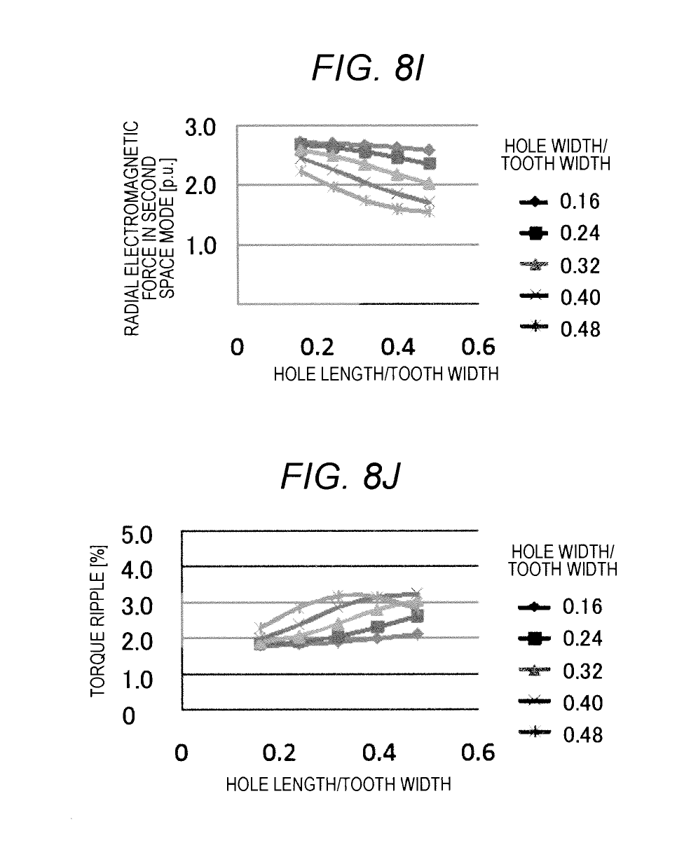

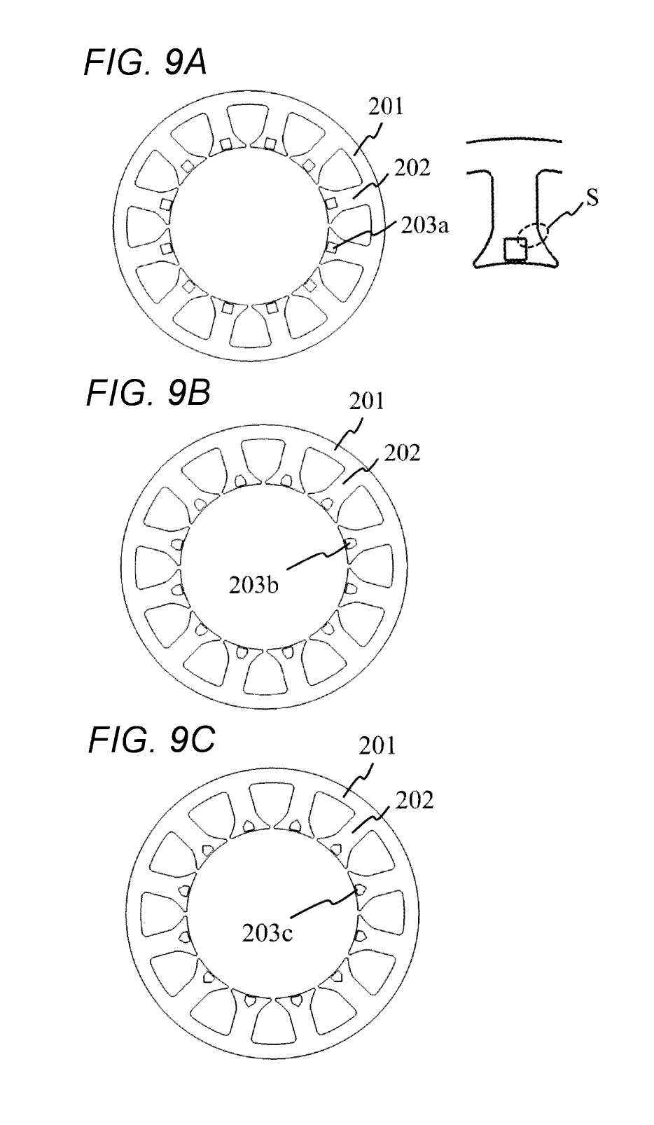

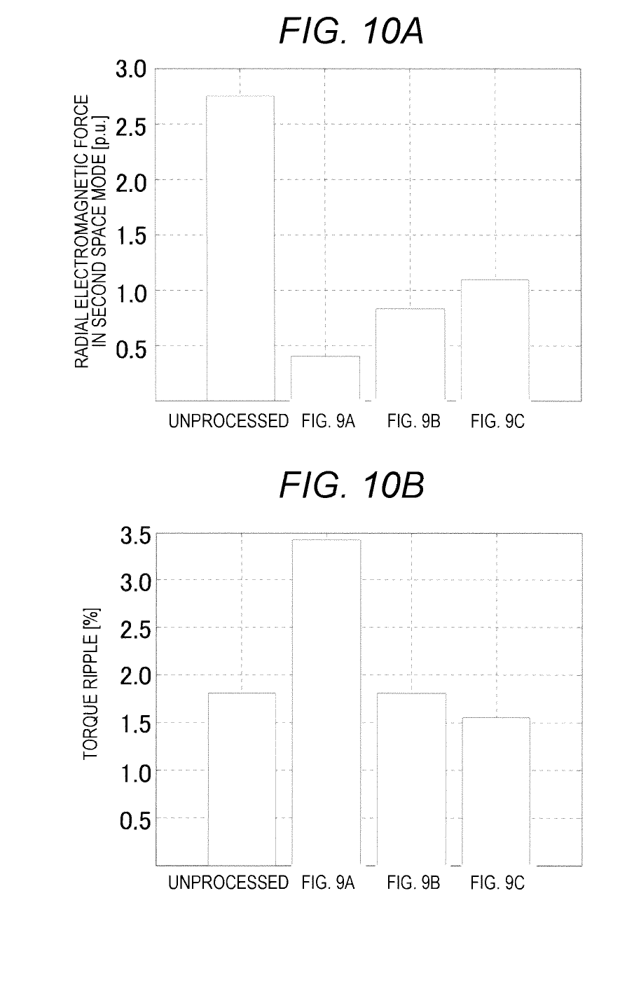

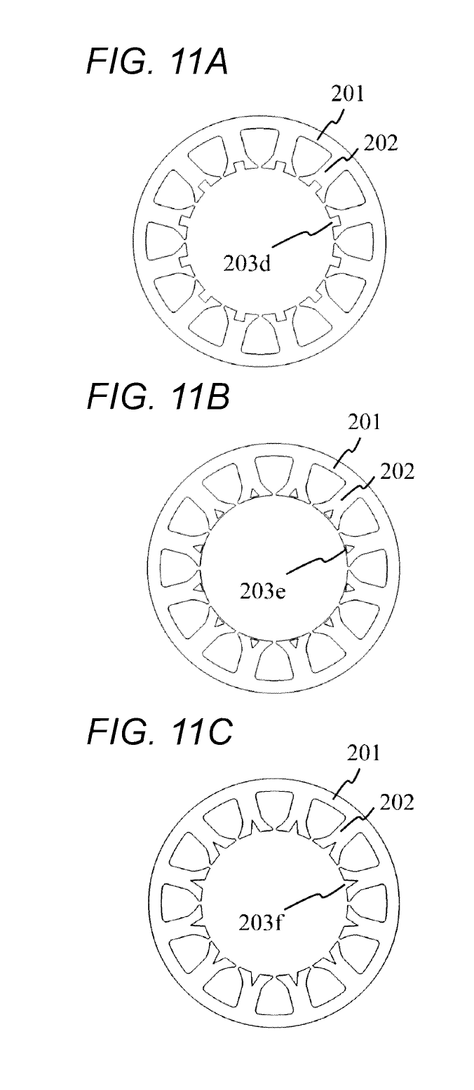

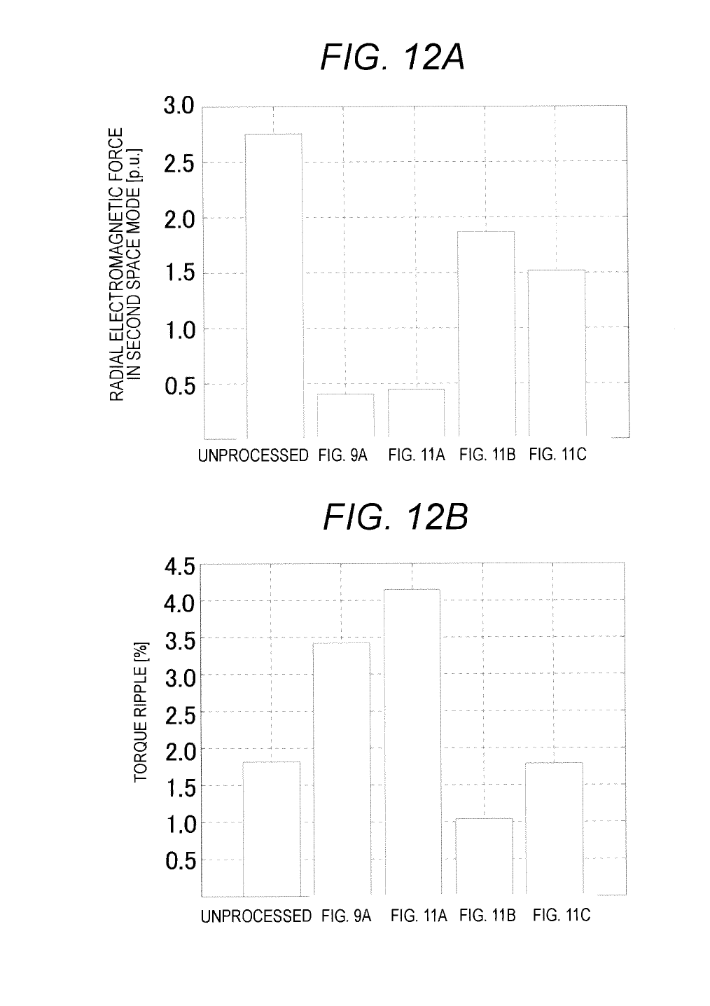

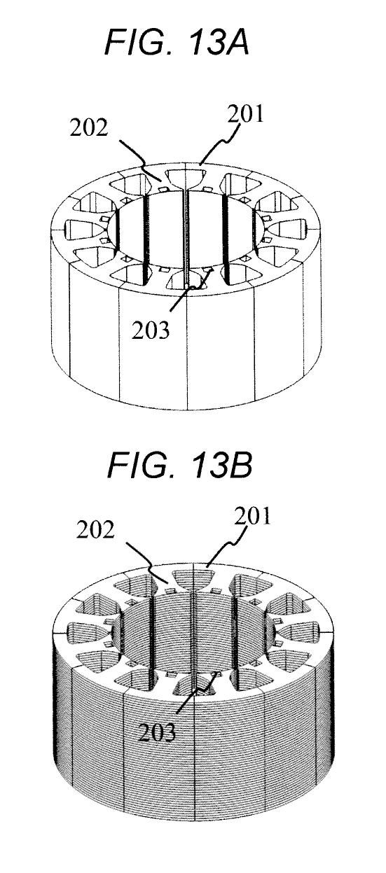

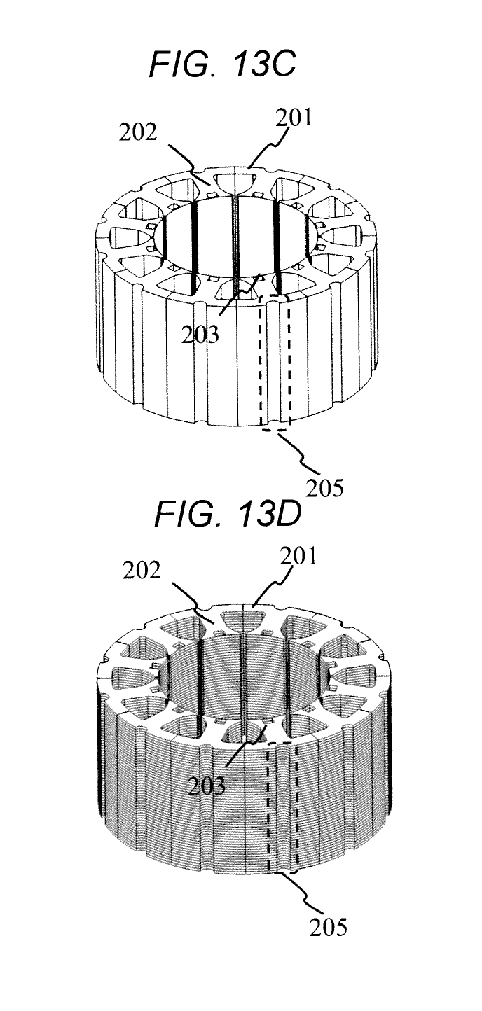

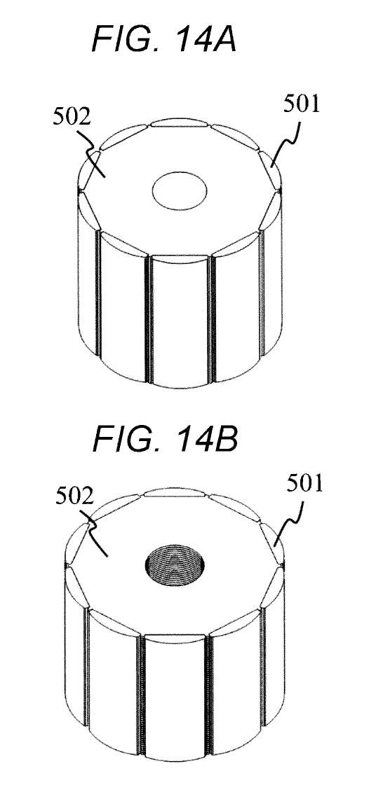

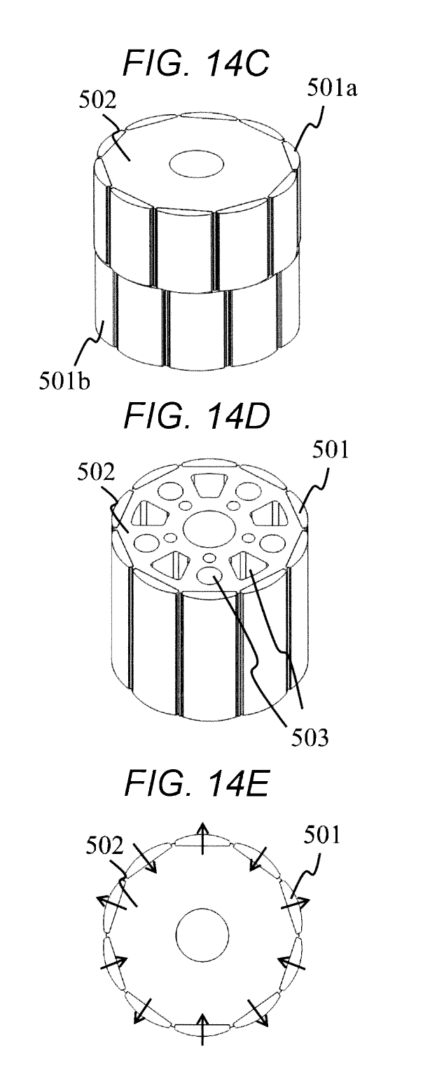

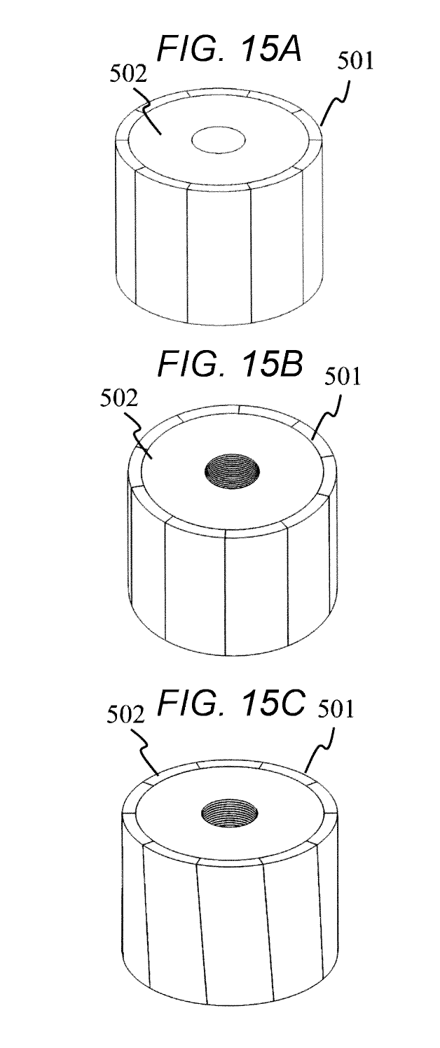

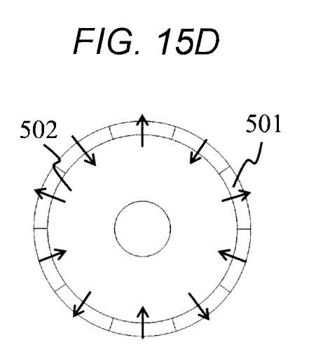

FIG. 8F is a graph illustrating the calculation result of torque ripple generated in an electric power steering motor according to an embodiment of the present invention, where bridge width/tooth width=0.13;

FIG. 8G is a graph illustrating the calculation result of electromagnetic force in a radial direction in a second space mode generated in an electric power steering motor according to an embodiment of the present invention, where bridge width/tooth width=0.16;

FIG. 8H is a graph illustrating the calculation result of torque ripple generated in an electric power steering motor according to an embodiment of the present invention, where bridge width/tooth width=0.16;

FIG. 8I is a graph illustrating the calculation result of electromagnetic force in a radial direction in a second space mode generated in an electric power steering motor according to an embodiment of the present invention, where bridge width/tooth width=0.24;

FIG. 8J is a graph illustrating the calculation result of torque ripple generated in an electric power steering motor according to an embodiment of the present invention, where bridge width/tooth width=0.24;

FIG. 9A is a diagram illustrating an axial cross-sectional shape of a stator core provided in an electric power steering motor according to an embodiment of the present invention, the stator core having a rectangular hole;

FIG. 9B is a diagram illustrating an axial cross-sectional shape of a stator core provided in an electric power steering motor according to an embodiment of the present invention, the stator core having a hexagonal hole;

FIG. 9C is a diagram illustrating an axial cross-sectional shape of a stator core provided in an electric power steering motor according to an embodiment of the present invention, the stator core having a pentagonal hole;

FIG. 10A is a graph illustrating the calculation result of electromagnetic force in a radial direction in a second space mode where a stator core has each of the hole shapes illustrated in FIGS. 9A to 9C;

FIG. 10B is a graph illustrating the calculation result of torque ripple where a stator core has each of the hole shapes illustrated in FIGS. 9A to 9C;

FIG. 11A is a diagram illustrating an axial cross-sectional shape of a stator core provided in an electric power steering motor according to an embodiment of the present invention, the stator core having a rectangular groove;

FIG. 11B is a diagram illustrating an axial cross-sectional shape of a stator core provided in an electric power steering motor according to an embodiment of the present invention, the stator core having a triangular hole;

FIG. 11C is a diagram illustrating an axial cross-sectional shape of a stator core provided in an electric power steering motor according to an embodiment of the present invention, the stator core having a triangular groove;

FIG. 12A is a graph illustrating the calculation result of electromagnetic force in a radial direction in a second space mode where a stator core has each of the hole shapes illustrated in FIGS. 11A to 11C;

FIG. 12B is a graph illustrating the calculation result of torque ripple where a stator core has each of the hole shapes illustrated in FIGS. 11A to 11C;

FIG. 13A is a detail view of a stator core provided in an electric power steering motor according to an embodiment of the present invention;

FIG. 13B is a detail view of a stator core provided in an electric power steering motor according to an embodiment of the present invention;

FIG. 13C is a detail view of a stator core provided in an electric power steering motor according to an embodiment of the present invention;

FIG. 13D is a detail view of a stator core provided in an electric power steering motor according to an embodiment of the present invention;

FIG. 14A is a detail view of a rotor core and a rotor magnet that are provided in an electric power steering motor according to an embodiment of the present invention;

FIG. 14B is a detail view of a rotor core and a rotor magnet that are provided in an electric power steering motor according to an embodiment of the present invention;

FIG. 14C is a detail view of a rotor core and a rotor magnet that are provided in an electric power steering motor according to an embodiment of the present invention;

FIG. 14D is a detail view of a rotor core and a rotor magnet that are provided in an electric power steering motor according to an embodiment of the present invention;

FIG. 14E is a detail view of a rotor core and a rotor magnet that are provided in an electric power steering motor according to an embodiment of the present invention;

FIG. 15A is a detail view of a rotor core and a rotor magnet that are provided in an electric power steering motor according to an embodiment of the present invention;

FIG. 15B is a detail view of a rotor core and a rotor magnet that are provided in an electric power steering motor according to an embodiment of the present invention;

FIG. 15C is a detail view of a rotor core and a rotor magnet that are provided in an electric power steering motor according to an embodiment of the present invention; and

FIG. 15D is a detail view of a rotor core and a rotor magnet that are provided in an electric power steering motor according to an embodiment of the present invention.

### DESCRIPTION OF THE PREFERRED EMBODIMENTS

A rotating electrical machine according to the present invention will be described below with reference to the drawings. Note that the description of the rotating electrical machine as an electric power steering motor in the present embodiment can also be applied to a brushless motor in general.

### First Embodiment

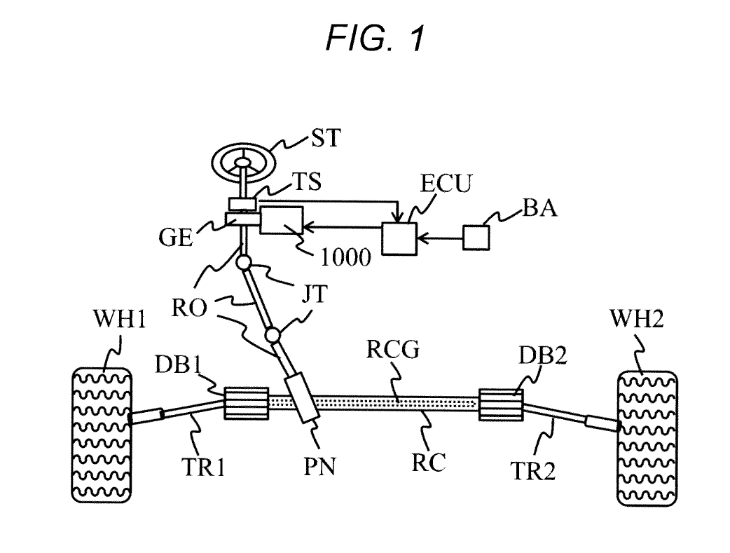

A first embodiment of the present invention will now be described. The operating principle of an electric power steering system according to the present invention will be described first with reference to FIGS. 1 to 3. An electric power steering system according to the present embodiment includes: an in-vehicle battery; a control unit which converts DC power supplied from the in-vehicle battery via a wire harness into polyphase AC power and controls the output thereof in accordance with torque applied onto a steering; and an electric power steering motor which is driven by the AC power supplied from the control unit in order to output torque to assist the steering. The electric power steering motor includes a frame, a stator fixed to the frame, and a rotor disposed in opposed relation to the stator with an air gap interposed therebetween, the stator including a stator core and a polyphase stator coil incorporated into the stator core. The stator core includes an annular back core portion and a plurality of tooth core portions which is projected into a radial direction from the back core portion. A slot is formed in the stator core between the adjacent tooth core portions, where the stator coil is stored in the slot. The rotor includes a rotor core and a plurality of magnets which is either fixed to the outer peripheral surface of the rotor core or embedded thereinto.

FIG. 1 is a block diagram illustrating the electric power steering system using the electric power steering motor according to the present embodiment. The system includes: a steering wheel ST; a torque sensor TS which detects rotary drive force of the steering wheel ST; a control unit ECU which controls assist torque on the basis of the output from the torque sensor TS; an electric power steering motor 1000 which outputs the assist torque on the basis of a signal from the control unit ECU controlling the assist torque; an in-vehicle battery BA which serves as the source of energy supplied to the control unit ECU and the motor 1000; a gear mechanism GE which decelerates the rotary drive force of the motor 1000 by a gear to output a desired torque; a pinion gear PN which conveys the torque generated by the gear mechanism GE; one or a plurality of rods RO which connects the pinion gear PN and the gear mechanism GE; one or a plurality of joints JT which connects the rod that connects the pinion gear and the gear mechanism; a rack gear RCG which transforms the rotary drive force generated in the pinion gear PN into horizontal force; a rack case RC which covers the rack gear; a first dust boot DB1 and a second dust boot DB2 which are provided to prevent dust or the like from entering the rack case; a first tire WH1 and a second tire WH2 which actually steer the vehicle; a first tie rod TR1 which conveys the horizontal force generated in the rack shaft to the first tire WH1; and a second tie rod TR2 which likewise conveys the horizontal force generated in the rack shaft to the second tire WH2.

FIG. 1 illustrates a column assist-type electric power steering system where the motor 1000 for generating the assist torque is provided in the vicinity of a steering column. In the system illustrated in FIG. 1, the rotary drive force generated by rotating the steering wheel ST is detected by the torque sensor TS. The control unit ECU then calculates an energizing pattern that generates a desired assist torque on the basis of a signal detected by the torque sensor TS, and outputs a command to the motor 1000. On the basis of the command from the control unit ECU, the motor 1000 is energized to generate the assist torque, which is then decelerated by the gear mechanism GE connected to the motor 1000 so that the rotary drive force is conveyed to the pinion gear PN via the rod RO and the joint JT. The pinion gear PN is in mesh with the rack gear RCG, whereby the rotary drive force of the pinion gear PN is transformed into the thrust force directed perpendicularly to the direction of travel of a vehicle. The horizontal thrust force then steers the tires WH1 and WH2 via the tie rods TR1 and TR2. This system can be used in the condition where the surrounding temperature is relatively low because the motor is arranged in the vehicle interior away from an engine room. As a result, the system can be designed with a relatively lenient condition regarding yield strength against demagnetization when the system includes a permanent magnet motor using a neodymium sintered magnet that may possibly be demagnetized at a high temperature. Disposed close to a driver, however, the system need be designed under a stringent condition regarding vibration and noise of the motor. While the control unit ECU and the motor 1000 are illustrated separately in FIG. 1, the control unit ECU may also be connected to the motor 1000 on the side opposite from the output shaft thereof to integrally serve as a mechatronic unit.

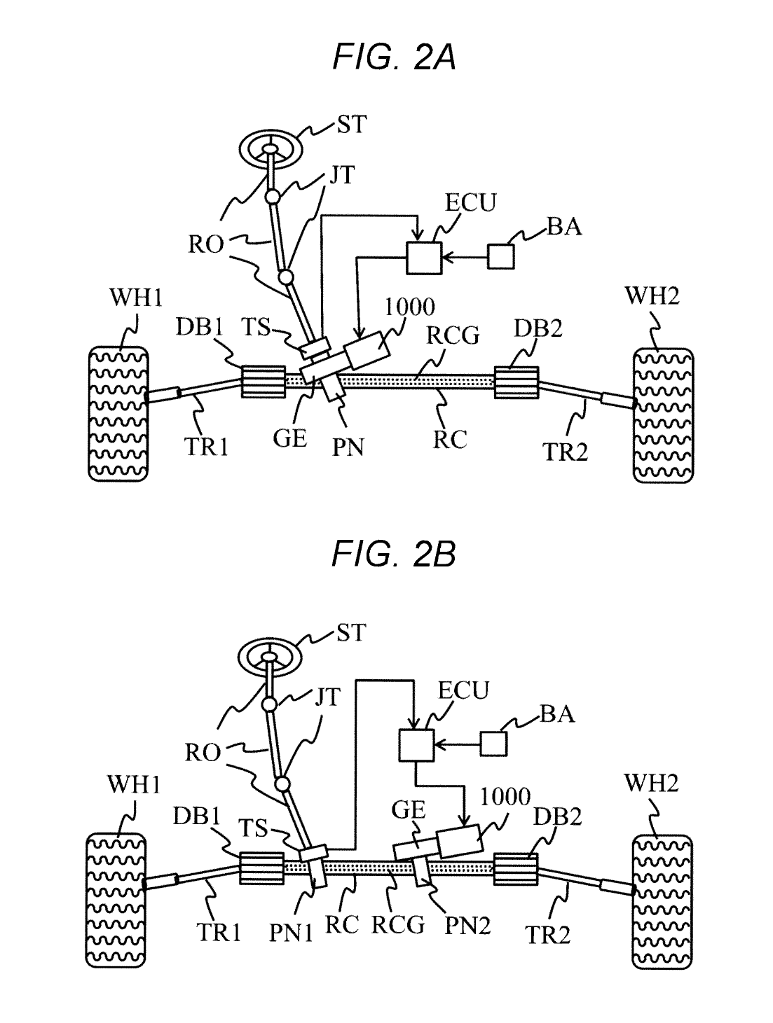

FIGS. 2A and 2B illustrate a pinion assist-type electric power steering system where the motor 1000 for generating the assist torque is provided in the vicinity of the pinion shaft. In the system illustrated in FIG. 2A, the pinion shaft is provided with the motor 1000 that generates the assist torque, but the basic operating principle of the system is no different from that of the column assist-type electric power steering system illustrated in FIG. 1. Moreover, FIG. 2B illustrates the system where, in addition to a first pinion shaft PN1 connected to the steering wheel ST through the rod RO, a second pinion shaft PN2 is provided in a direction opposite to the center of the rack shaft, the second pinion shaft PN2 being provided with the motor 1000 that generates the assist torque. Being provided with two pinion gears, the system is referred to as a dual pinion assist-type electric power steering or a double pinion assist-type electric power steering. The motor in this system can be increased in size to achieve high power due to the fact that both the steering force by a human and the assist torque are applied to the rack gear RCG, and that a space for disposing the motor 1000 can be secured due to the pinion shaft additionally being provided. Moreover, the system can be designed with a relatively lenient condition regarding vibration and sound because the motor 1000 and the driver are a long distance away from each other. Being disposed in the engine room where the surrounding temperature is relatively high, on the other hand, the system need be designed with a relatively stringent condition regarding the yield strength against demagnetization when the system employs the permanent magnet motor using the neodymium sintered magnet that may possibly be demagnetized at a high temperature.

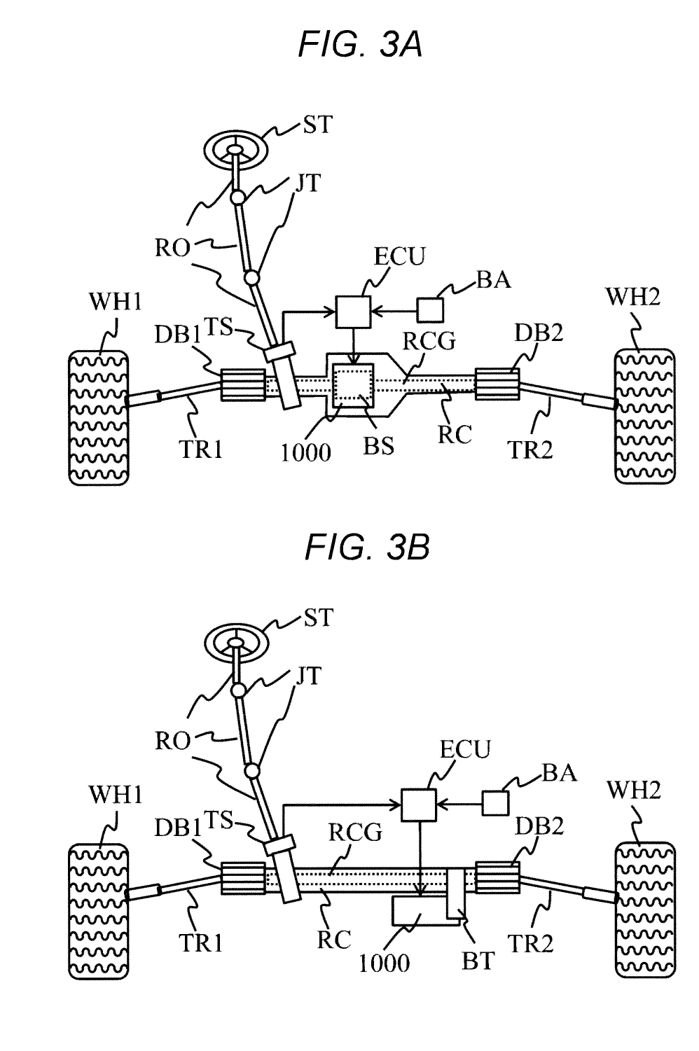

FIGS. 3A and 3B illustrate a rack assist-type electric power steering system where the motor 1000 that generates the assist torque is provided coaxially with the rack gear RCG. In the system illustrated in FIG. 3A, the motor 1000 for generating the assist torque is built into the rack case RC. The motor 1000 having adopted a hollow shaft structure includes therein a ball screw BS formed by cutting a screw. The rotary drive force of the motor 1000 is converted into the horizontal thrust force of the rack gear RCG when the ball screw BS meshes with the rack gear RCG. In the system illustrated in FIG. 3B, the motor 1000 for generating the assist torque is provided in parallel with the rack gear RCG. In this case, the rotor shaft of the motor 1000 and the rack gear are connected by a belt BT, so that the rotary drive force of the motor 1000 is converted into the horizontal thrust force of the rack gear RCG when the rack gear RCG meshes with the belt BT into which a screw-like groove is incised. The system can be designed with a relatively lenient condition regarding vibration and sound because the motor 1000 and a driver are a long distance away from each other as with the pinion assist-type electric power steering that is illustrated in FIGS. 2A and 2B. Being disposed in the engine room where the surrounding temperature is relatively high, on the other hand, the system need be designed with a relatively stringent condition regarding the yield strength against demagnetization when the system employs the permanent magnet motor using the neodymium sintered magnet that may possibly be demagnetized at a high temperature. In addition, the structure in this system allows for the rational and effective use of the space and is thus favorable for achieving even higher power by increasing the motor in size, for example.

The energy balance among the motor 1000, the control unit ECU, and the battery BA will now be described. When a 12 V, 100 A battery BA is used to power the motor 1000, for example, the output of the battery is approximately 1200 W. The battery BA and the control unit ECU are connected by the wire harness, the power consumed by which is approximately 200 W with the large current flowing through it even when the low resistance is achieved by using the wire harness with a large diameter (a wire harness with a conductor cross-sectional area of around 8 MM² is the maximum limit considering the easiness of routing). The power consumed by the control unit ECU is around 200 to 300 W even when the internal resistance of the control unit ECU itself is decreased. This means that about half the power (approximately 1200 W) that can be output from the battery BA is consumed by the wire harness and the control unit ECU, thereby reducing the power that can be consumed by the motor 1000 by half. A counter-electromotive force of the motor 1000 is proportional to the rotational speed and the number of coil turns, meaning that the counter-electromotive force generated by the motor surpasses the input voltage when the motor runs in a high rotational speed region, which would not hold as a system. Accordingly, the system need be designed such that it supports up to the high speed region by decreasing the number of coil turns.

The EPS motor is employed in a vehicle with small displacement (small gross weight), whereas a hydraulic power steering system is currently put into practical use in a vehicle with large displacement (large gross weight). It has been practically impossible to employ a permanent magnet brushless motor in the vehicle with large displacement or large gross weight (the displacement of 1.8 L or more or the gross weight of 1.5 t or heavier, for example). This is because the vehicle with large displacement (large gross weight) cannot perform static steering owing to the large vehicle weight which causes great amount of friction between the steering and the ground.

The permanent magnet-type concentrated winding brushless motor cannot achieve large torque when running at low speed due to large copper loss in the motor, thereby preventing the sufficient amount of motor current from flowing into the motor in accordance with the aforementioned energy balance. Therefore, the EPS needs to employ a motor with small copper loss. Moreover, there is a merit in sufficiently reducing the copper loss such that the heat of the motor is not conveyed to the side of the ECU of the mechatronic unit where the motor and the ECU are designed integrally.

The EPS motor requires downsizing regardless of whether it is disposed in the vicinity of the steering column or the rack and pinion as illustrated in FIGS. 1 to 3. The stator winding needs to be fixed in the motor that is downsized, where it is also important that the winding work is made easy. In addition, it is desired that the torque variation such as cogging torque be suppressed to the very low level in the EPS motor, which however is required to generate large torque. For example, the motor is required to generate large torque when a driver quickly turns the steering wheel while a vehicle is in a halt state or in a running state near halt, because the frictional resistance is generated between the wheels being steered and the ground. At this time, a large current is supplied to the stator coil, the current being 50 amperes or greater in some cases depending on the condition. It may also be 70 or 150 amperes. The EPS mounted in a vehicle also receives vibration of various kinds as well as shock from a wheel. Moreover, the EPS motor is used under a state where there is a large change in temperature. That is, the motor may be subjected to the temperature of minus 40 degree Celsius, or 100 degree Celsius or higher due to the rise in temperature. Furthermore, the motor requires means to prevent water from flowing into it. In order for the stator to be fixed to a yoke under these conditions, it is desired that a stator sub-assembly be press-fitted into a cylindrical metal free of any holes other than a screw hole on the outer periphery of at least the stator core of a cylindrical frame. After press-fitting, the stator may be further screwed from the outer periphery of the frame. It is also desired that locking be performed in addition to press-fitting.

The EPS motor is driven by a power source installed in a vehicle, the power source often having a low output voltage. A series circuit is equivalently formed of a switching element constituting an inverter across a power supply terminal, the motor, and another current supply circuit connecting means. In this circuit, the sum of a terminal voltage of each circuit component is the voltage across terminals of the power source, whereby the terminal voltage of the motor to supply current thereto is lowered. In order to secure the current flowing into the motor under such condition, it is especially important to keep the copper loss of the motor to a low level. From this point of view, the power source installed in a vehicle often has a low voltage specification of 50 volts or less, and it is desired that a stator coil 400 be wound by the concentrated winding method, which is especially important when using a 12-volt power source.

As described above, it is often the case that the performance of the motor having a large number of poles cannot be obtained sufficiently in a high rotational speed region when the 12-volt power source is used. Therefore, the number of poles of the motor is preferably between 6 and 14. Here, the concentrated winding motor with 12 slots will be described as an example, the motor with 12 slots providing many options for the number of poles for the same number of slots within the range of the number of poles between 6 and 14.

In the permanent magnet rotating electrical machine where the number of poles of the permanent magnet is denoted by P, the number of salient poles of the stator is denoted by S, the least common multiple between P and S is denoted by N, and the greatest common divisor between P and S is denoted by M, the least common multiple N corresponds to the number of ripples in a circumferential direction per rotation of the motor that is not energized, that is, the order of cogging torque per rotation. The cogging torque represents the change in magnetic energy incident to the movement of the rotor. The greater the least common multiple N, the smaller the fluctuation of the cogging torque. The greatest common divisor M specifies a vibration mode of the rotating electrical machine. That is, the greatest common divisor specifies the mode number (a vibration cycle in a circumferential direction) when a stator 200 in the permanent magnet rotating electrical machine illustrated in FIG. 5 receives electromagnetic stress to generate vibration in a circular mode. The vibration is suppressed by the increase in the mode number, whereby the motor with less vibration can be realized.

Take for example an 8-pole, 12-slot motor and a 10-pole, 12-slot motor. In the 8-pole, 12-pole motor, the least common multiple N between the number of poles and the number of slots is 24, meaning that there will be large cogging torque and torque ripple, and that the rotor magnet will need to be skewed or the like in order to satisfy the performance as the EPS motor with which the steering feeling is weighed heavily. In the 10-pole, 12-slot motor, on the other hand, the least common multiple N is 60, meaning that the cogging torque and the torque ripple can be reduced significantly. Now, the 8-pole, 12-slot motor and the 10-pole, 12-slot motor have the greatest common divisor of 4 and 2, respectively. This means that the 10-pole, 12-slot motor is in a low circular mode where the vibration is more likely to occur. In particular, the motor in the second circular mode causes a large elliptical motion, whereby the stator and the housing is more likely subjected to deformation. Thus, a low order circular mode can cause vibration more easily. By reducing the electromagnetic force in the low circular mode, there can be provided a motor that is less likely to cause vibration and noise.

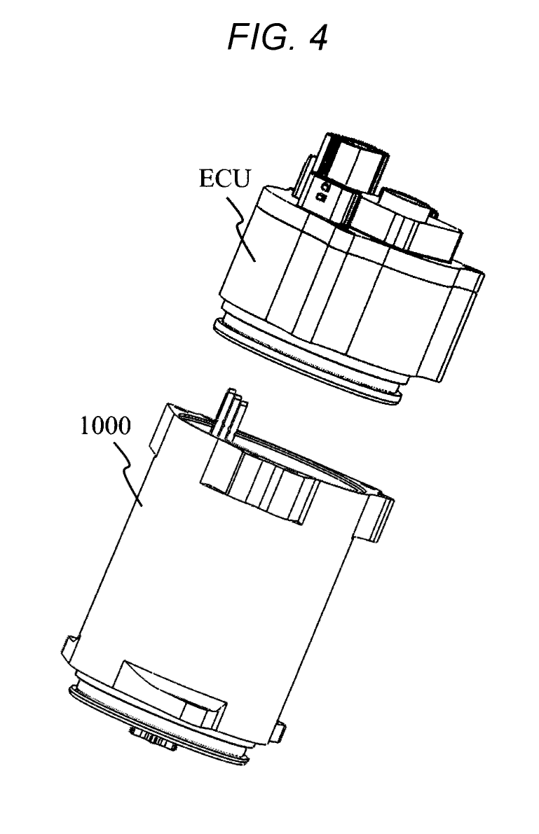

The detail structure of the EPS motor 1000 according to the first embodiment of the present invention will now be described with reference to FIGS. 4 and 5. When a human attempts to steer a tire via a steering wheel, the EPS motor according to the present invention is energized on the basis of a signal from the control unit ECU controlling the assist torque and outputs the assist torque. The arrangement of the control unit ECU and the motor 1000 will be described. As illustrated in FIGS. 1 to 3, the control unit ECU can be either arranged separately from the motor 1000 and connected thereto through the wire harness or the like, or connected directly to the motor 1000 on the opposite side of the output thereof to integrally form the mechatronic unit so as to avoid voltage drop or loss by the wire harness. When the mechatronic unit is employed as illustrated in FIG. 4, for example, the control unit ECU is directly connected to the motor 1000 on the side opposite to the output shaft thereof. A lead of the winding in the motor 1000 is brought into contact with and fixed to a metal portion through a bus bar so that the motor is wired by a Y connection or a Δ connection method through the bus bar. The wiring bound through the bus bar is then connected to the control unit ECU by an input line 802 that is projected to the control unit ECU side.

The overall structure of the motor 1000 will now be described with reference to FIG. 5A. The motor 1000 includes: a stator core 200 which is formed of a magnetic material and fixed to a housing case 100 made of iron or aluminum; a conductive stator coil 400 wound around the stator core 200; a bobbin 300 which is formed of a non-conductive member to insulate the stator core 200 from the stator coil 400; a rotor 500 which is rotatably supported on the inner diameter side of the stator 200; a bus bar 600 which forms the input line for the motor by putting the lead of the stator coil 400 together or forms a neutral point where the Y connection method is employed; a bracket 700 which is provided on the input side of the motor 1000; and a base 800 on which the input line 802 and a relay switch 801 are placed together.

The aforementioned components are fabricated by the following method including: a first process of incorporating the stator coil into the stator core 200; a second process of press-fitting, into the housing case 100, a plurality of circumferential portions of the stator core 200 into which the stator coil 400 has been incorporated and obtaining a structure in which the stator core 200 into which the stator coil 400 has been incorporated is fixed to the housing case 100; and a third process of attaching the bracket 700 or a jig to the structure such that the stator core 200 and the coil end portion of the stator coil 400 projected from the axial end of the stator core 200 toward the axial direction are enclosed with the bracket 700 or the jig and the housing case 100. This method may also be adapted to a method of manufacturing a structure molded by a mold material by performing, after the third process: a fourth process of injecting the mold material fluid into the space enclosed with the bracket 700 or the jig and the housing case 100 so that the mold material fills up the coil end portion, a gap in the stator core 200, a gap in the stator coil 400, a gap between the stator core 200 and the stator coil 400, and a gap between the stator core 200 and the housing case 100; a fifth process of solidifying the mold material; and a sixth process of removing the jig.

The structure of the rotor 500 will now be described with reference to FIG. 5B. The rotor 500 includes: at least one rotor magnet 501 that is a permanent magnet disposed in the circumferential direction of the rotor; a rotor core 502 which fixes the permanent magnet in position; a magnet cover 503 which is provided for the rotor magnet 501 to be able to withstand the centrifugal force generated by rotation; a shaft 504 which is fixed on the inner diameter side of the rotor core; bearing mechanisms 505 and 506 which rotate the shaft 504; and a load-side fitting member 507 which is connected to a gear and a load provided on the motor output side.

The structure of the stator core 200 and the bobbin 300 will now be described with reference to FIG. 5C. Each core includes a toric stator core back portion 201 and a stator tooth portion 202 which is projected toward the internal diameter from the core back. This split core arranged in the circumferential direction constitutes the stator core 200 illustrated in FIG. 5A. As illustrated in FIG. 5C, the bobbin 300 for insulating the stator core 200 from the stator coil 400 is split into bobbins 301 and 302 toward both sides of the axial direction, the bobbins 301 and 302 interposing therebetween the stator tooth portion 202 from the axial direction when assembled. Here, the EPS motor is often powered by a large current using a low-voltage battery such as a 12-V battery, whereby the winding with a large wire diameter is required. A space factor of the winding need also be increased in order to supplement the required assisting force. For this reason, it is useful to use the split core, which is thus described as an example in the present embodiment. The similar effects of the present invention can however be obtained by using an integrated core, in which case the wire diameter of the winding is small relative to a slot opening width.

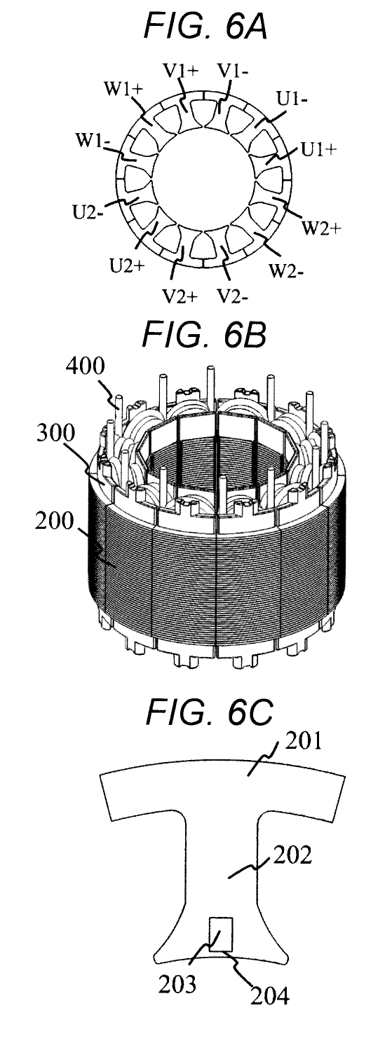

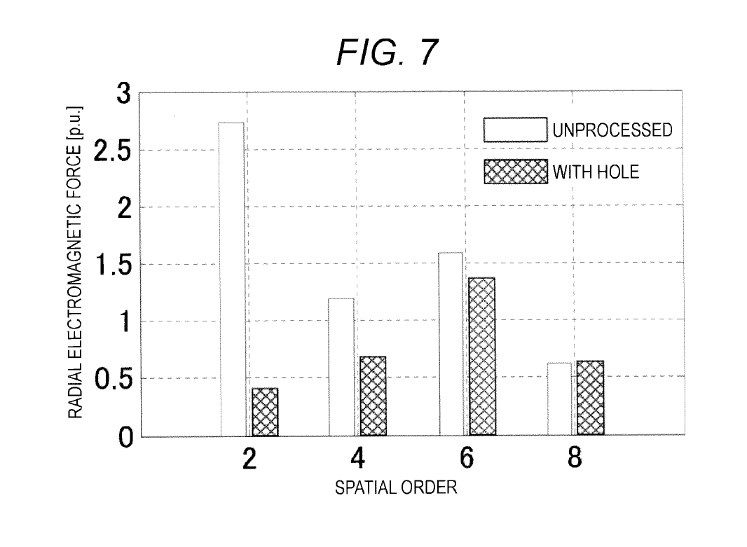

FIGS. 6A to 6C are diagrams provided for describing the present embodiment. While the 10-pole, 12-slot motor will be described as an example, the similar effect can be obtained by a motor having the combination of the same number of poles and the number of slots. FIG. 6A illustrates a cross-sectional structure of the stator for the 10-pole, 12-slot or the 14-pole, 12-slot concentrated winding motor. As illustrated in FIG. 6A, the stator coil is wound around each of 12 independent teeth by the concentrated winding method counter-clockwise in the order of U1+, U1−, V1−, V1+, W1+, W1−, U2−, U2+, V2+, V2−, W2−, and W2+. The stator coils U1+ and U1− are wound such that the current flows through these coils in the mutually opposite directions. Likewise, the stator coils U2+ and U2− are wound such that the current flows through these coils in the mutually opposite directions. The stator coils U1+ and U2+ are wound such that the current flows through these coils in the same direction. Likewise, the stator coils U1− and U2− are wound such that the current flows through these coils in the same direction. The directional relationship of the current flowing through the stator coils V1+, V1−, V2+, and V2− and through the stator coils W1+, W1−, W2+, and W2− is similar to that of the U-phase coil.

Each of the 12 stator cores 200 and the stator coil 400 are manufactured in the similar manner. When two parallel circuits are provided for the U-phase coil including four teeth, for example, two of the stator coils continuously wound around the teeth in series and another two of the stator coils continuously wound around the teeth in series are connected through the bus bar or the like. When one parallel circuit is provided, on the other hand, all the stator coils are wound around the four teeth in a continuous manner. FIG. 6B illustrates the stator core 200 including the integrated core or the split core arranged in the circumferential direction. Incidentally, the stator core 200 is formed by laminating a thin plate formed of a magnetic material such as a magnetic steel sheet in the axial direction. This structure is effective at reducing eddy current loss generated in the stator. FIG. 6C is an axial cross-sectional view of the stator core corresponding to one tooth. The stator core includes the toric core back portion 201 and the stator tooth portion 202 which is projected toward the internal diameter from the core back, where the tip of the stator tooth portion 202 toward the internal diameter is formed wider in the circumferential direction. The large cross-sectional area secured between the point where the stator tooth portion 202 starts to widen and the tip thereof provides the effect of alleviating magnetic saturation and suppressing torque ripple. In the present embodiment, there is at least one hole 203 provided at the circumferential center of the tip of the stator tooth portion 202 toward the internal diameter. The hole 203 is effective at reducing the electromagnetic force in the radial direction and thus the source of vibration. The hole 203 is bored by punching or wire cutting as is the case with the manufacture of the stator core 200. Moreover, the hole 203 has a bridge 204 at a location toward the internal diameter of the stator tooth portion 202, the bridge being connected through the core.

FIG. 7 is a graph illustrating a peak value of the radial electromagnetic force generated in the 10-pole, 12-slot motor at a certain time, the peak value being illustrated for each spatial order. It can be understood from FIG. 7 that the electromagnetic force in the second space mode can be significantly reduced by the hole provided at the tip of the stator. Note that the hole 203 provided in the form of a vacant portion in the present embodiment may be a nonmagnetic member or a member having low magnetic permeability for the stator core. The aforementioned structure can also be substituted by swaging work or the like.

### Second Embodiment

A second embodiment of the present invention will now be described with reference to FIGS. 8A to 8J. FIGS. 8A to 8J illustrate the relationship between each of the length (in the radial direction) and the width (in the circumferential direction) of the hole, and each of the radial electromagnetic force in the second space mode and the torque ripple for different proportions of the bridge 204 of the stator core described in the first embodiment to the width of the stator tooth portion 202 (hereinafter referred to as bridge width/tooth width) in the 10-pole, 12-slot motor. FIGS. 8A and 8B are graphs illustrating the calculation result when bridge width/tooth width≈0.03. FIGS. 8C and 8D are graphs illustrating the calculation result when bridge width/tooth width≈0.06. FIGS. 8E and 8F are graphs illustrating the calculation result when bridge width/tooth width≈0.13. FIGS. 8G and 8H are graphs illustrating the calculation result when bridge width/tooth width≈0.16. FIGS. 8I and 8J are graphs illustrating the calculation result when bridge width/tooth width≈0.24. Although the degree of the effect varies in each case illustrated in each of the graphs, it can be understood that the radial electromagnetic force in the second space mode is effectively reduced in all ranges. On the other hand, it can be confirmed from the graphs that the torque ripple is exacerbated as the length and the width of the hole are increased relative to the width of the stator tooth portion 202. When the torque ripple of 4% or less is set as a guideline in consideration of suppressing the increase in the torque ripple, it is desired that the range of the length and the width of the hole be, hole length/tooth width≦0.5 and hole width/tooth width≦0.48, for the bridge width/tooth width of between 0.03 and 0.06. For the bridge width/tooth width of between 0.13 and 0.20, it is desired that the range of the length and the width of the hole be, hole length/tooth width≦0.4 and hole width/tooth width≦0.48. For the bridge width/tooth width of greater than 0.20, it is desired that the range of the length and the width of the hole be, hole length/tooth width≦0.5 and hole width/tooth width≦0.48.

### Third Embodiment

A third embodiment of the present invention will now be described with reference to FIGS. 9A to 9C. FIG. 9A illustrates the stator core having a rectangular hole. When the hole has the shape as illustrated in FIG. 9A, the area where a magnetic flux passes through becomes smaller in proportion to the length and the width of a rectangular hole 203a provided at the tip of the stator tooth portion 202, the area corresponding to a portion where the tip of the stator tooth portion 202 toward the internal diameter starts to widen in the circumferential direction. This aggravates the magnetic saturation that can possibly cause the increase in the torque ripple, whereby the length and the width of the hole require some constraint. In this regard, as illustrated in the second embodiment, the radial electromagnetic force can be reduced while suppressing the increase in the torque ripple by imposing the constraint on the width and the length of the hole. Accordingly, the present embodiment will focus on the alleviation of the magnetic saturation in the tooth and thus describe the shape of the hole. As described above, it is the portion where the core starts to widen that affects the magnetic saturation and the torque ripple, where a cross-sectional area S illustrated in FIG. 9A becomes smaller as the length and the width of the hole 203 become larger, thereby aggravating the magnetic saturation and causing the torque ripple to be increased. This means that the magnetic saturation can be alleviated and that the increase in the torque ripple can be suppressed by reducing the width of the hole 203 toward the external diameter. For example, as illustrated in FIG. 9B, the hole can be formed into a hexagonal shape by cutting the tip of a hexagonal hole 203b toward the external diameter into a trapezoidal shape, the hexagonal hole being provided at the tip of the stator tooth portion. Alternatively, as illustrated in FIG. 9C, the magnetic saturation in the cross-sectional area S can be alleviated by forming a pentagonal hole 203c by cutting the tip of the hole 203 toward the external diameter into a triangular shape, the hole being provided at the tip of the stator tooth portion.

FIG. 10A illustrates the calculation result of the radial electromagnetic force in the second space mode of the 10-pole, 12-slot motor for each case where the stator tooth portion has each of the hole shapes illustrated in FIGS. 9A to 9C. By narrowing the tip of the hole 203 toward the external diameter as illustrated in FIGS. 9B and 9C, the radial electromagnetic force can be reduced significantly, though not as much as the case with the hole illustrated in FIG. 9A, compared with the stator tooth portion having no hole. FIG. 10B illustrates the calculation result of the torque ripple under the same condition as described above. The torque ripple is exacerbated where the tip of the hole 203 toward the external diameter is not narrowed as compared to the stator tooth having no hole, while the increase in the torque ripple can be suppressed by the hole shapes illustrated in FIGS. 9B and 9C.

### Fourth Embodiment

A fourth embodiment of the present invention will now be described with reference to FIGS. 11A to 11C. FIG. 11A illustrates the form of the stator core having a rectangular groove 203d formed by cutting off the bridge of the rectangular hole 203a provided in the stator core illustrated in FIG. 9A. As illustrated in the aforementioned embodiments, there is a merit in forming the groove that is easier to manufacture than the bridge in consideration of the positional accuracy of the hole or the like. As is known by JP-2011-67090-A, however, the technique of reducing the cogging torque by providing a groove at the tip of the stator tooth is a technique already known. While the width and the depth of the groove are typically made equal to the width of a slot opening in the aforementioned known technique, the width and the depth of the groove in the present embodiment are greater than the width of the slot opening, namely, preferably greater than or equal to 30 percent the width of the stator tooth. FIG. 11B illustrates the form of the stator core having a triangular hole 203e at the tip of the stator tooth portion. This hole shape allows the cross-sectional area S illustrated in FIG. 9A to be increased so that both the radial electromagnetic force and the torque ripple can be reduced, as described in the third embodiment. FIG. 11C illustrates the form of the stator core having a rectangular groove 203f formed by cutting off the bridge of the triangular hole 203e illustrated in FIG. 11B. As with FIG. 11A, the groove is formed in consideration of the positional accuracy of the hole or the like. The width of the groove in this case is also greater than the width of the slot opening, preferably greater than or equal to 30 percent of the tooth width.

FIG. 12A illustrates the calculation result of the radial electromagnetic force in the second space mode of the 10-pole, 12-slot motor for each case where the stator tooth portion has each of the hole shapes illustrated in FIGS. 11A to 11C. Also included in FIG. 12A for comparison is the calculation result for the stator having the rectangular hole illustrated in FIG. 9A. As illustrated in FIG. 12A, the rectangular groove is as effective as the hole in reducing the radial electromagnetic force. The triangular hole and the groove formed in the stator tooth portion can reduce the radial electromagnetic force by 30 percent or more which although is not as much as the case with the rectangular hole or groove. On the other hand, as illustrated in FIG. 12B, the triangular hole and groove are superior to the rectangular hole or groove in terms of reducing the torque ripple.

Hereinafter, the structure of the stator and the rotor of the motor according to the present embodiment will be described in detail.

FIGS. 13A to 13D are diagrams illustrating the structure of the stator. The stator core requires various means to be implemented in order to suppress the loss generated in the core as much as possible. Take for example the stator core including 12 split cores as illustrated in FIG. 13A. There is a large eddy current loss when each split core is formed of pure iron, while the eddy current generated in the core can be suppressed when the split core is formed of a pressed powder core or the like. The eddy current can also be suppressed by employing a laminate of steel sheets in which a thin sheet-like soft magnetic material is laminated in the axial direction as illustrated in FIG. 13B. In this case, the thinner the sheet, the more effectively the eddy current can be suppressed. Moreover, a groove provided in the radial direction of the split core in both of the stator cores illustrated in FIGS. 13A and 13B allows a fixing jig such as a through-bolt to pass through the groove. FIG. 13C is a diagram illustrating the stator core formed of the pressed powder core, whereas FIG. 13D is a diagram illustrating the stator core formed of the steel sheet laminate. It is desired that a groove on the radially outer side of stator core 205 be provided on the radially outer side of the tooth by taking the path of the magnetic flux into consideration. Moreover, it is even better to round the corner of the radially outer side of the slot in order to alleviate the magnetic saturation. Furthermore, the tooth of the stator core is smoothly spread out in the shape of a brass instrument toward the internal diameter side in order to alleviate the magnetic saturation when loaded.

FIG. 14A is a diagram illustrating the structure of the rotor. The rotor core 502 is formed of a magnetic material, where the rotor magnet 501 segment is stuck to the surface of the pure iron. A locking mechanism is provided between the plurality of permanent magnets, between which the rotor core is projected. This projection is preferably about half as tall as the edge of the magnet so as to avoid an adverse effect caused when the projection is too tall in the radial direction. When there is a large eddy current loss in the rotor core, the rotor core may be formed of the pressed powder core or formed by laminating a thin electromagnetic steel sheet as illustrated in FIG. 14B. Moreover, the cross section of each rotor magnet 501 has a semicylindrical or “kamaboko” shape. The kamaboko shape has the radial thickness that is smaller on both sides than at the center in the circumferential direction. This kamaboko shape allows the magnetic flux to have a sinusoidal distribution, whereby the induced voltage generated by the rotation of the EPS motor has a sinusoidal waveform so that the ripple can be reduced. The steering feeling perceived by a driver can be improved by the reduction of the ripple. Note that when the magnet is formed by magnetizing the ring-shaped magnetic material, the magnetizing force may be controlled such that the magnetic flux has a distribution that resembles the sinusoidal distribution. Moreover, as illustrated in FIG. 14C, a rotor magnet 501a and a rotor magnet 501b can be stacked in the axial direction so that, by shifting at least one of the rotor magnets by a predetermined angle in the circumferential direction, the ripple in the rotor magnetomotive force can be cancelled in the axial direction to reduce the cogging torque and the torque ripple. Furthermore, a hole provided in the rotor core as illustrated in FIG. 14D can be used for positioning the rotor or suppressing the moment of inertia. In this case, it is desired that the hole be positioned at some distance away from the magnet in order to not interfere with the path of the magnetic flux. Alternatively, the rotor magnet 501 is magnetized in the direction that alternates between the adjacent magnets as illustrated in FIG. 14E.

FIGS. 15A to 15D are diagrams likewise illustrating the structure of the rotor. As illustrated in FIG. 15A, the rotor core 502 is formed of a magnetic material, where the ring-shaped rotor magnet 501 is stuck to the surface of the pure iron. When there is a large eddy current loss in the rotor core, the rotor core may be formed of the pressed powder core or formed by laminating a thin electromagnetic steel sheet as illustrated in FIG. 15B. When a ring magnet is employed, the magnet can also be skewed in a continuous manner. That is, as illustrated in FIG. 15C, the magnet can be skewed in the axial direction at a predetermined angle so that the cogging torque and the torque ripple can be reduced. The permanent magnet is magnetized in the direction such that each pole is magnetized in parallel with the direction of an arrow illustrated in FIG. 15D, or otherwise magnetized radially along the circle of the rotor magnet.

What is claimed is:

1. A permanent magnet rotating electrical machine comprising:
a stator including:
a stator core; and
a polyphase stator coil incorporated into the stator core; and
a rotor including:
a rotor core; and
a plurality of permanent magnets which is fixed to an outer peripheral surface of the rotor core,
wherein the stator core has a plurality of stator tooth portions forming a slot into which the stator coil is stored,
the rotor core is rotatably disposed in opposed relation to the stator, and
the stator tooth portion includes at a tip thereof at least one nonmagnetic inner region.

2. The permanent magnet rotating electrical machine according to claim 1, wherein the inner region corresponds to at least one hole.

3. The permanent magnet rotating electrical machine according to claim 1, wherein the inner region corresponds to at least one groove.

4. The permanent magnet rotating electrical machine according to claim 1, wherein the inner region corresponds to at least one closed swaging region provided for laminating.

5. The permanent magnet rotating electrical machine according to claim 1, wherein the inner region is positioned at a tip of the stator tooth portion close to a side of the rotor.

6. The permanent magnet rotating electrical machine according to claim 4, wherein a circumferential width of the inner region is smaller toward a stator core back portion that is on a side opposite to the side of the rotor than on the side of the rotor.

7. The permanent magnet rotating electrical machine according to claim 1,
wherein the stator core includes the core back portion in a toric shape and the stator tooth portion which is projected toward an internal diameter from the core back portion, and
a center of the inner region in a circumferential direction is positioned at a center of the stator tooth portion in a circumferential direction.

8. The permanent magnet rotating electrical machine according to claim 1, wherein a ratio of the number of poles of the permanent magnet to the number of slots of the stator core is 10:12 or 14:12.

9. The permanent magnet rotating electrical machine according to claim 1, wherein the permanent magnet rotating electrical machine is used as an auxiliary machine for a vehicle.

10. The permanent magnet rotating electrical machine according to claim 1, wherein the permanent magnet rotating electrical machine is used for an electric power steering.
